(19) United States
(12) Patent Application Publication
(10) Pub. No.: US 2005/0256901 A1
(43) Pub. Date: Nov. 17, 2005

(54) Method and system for distribution of information

(75) Inventors: Andrew D J Banks, Michelmersh (GB); Michael Cobbett, Eastleigh (GB); David R. Vyvyan, Southampton (GB); Mark A. Wynn-MacKenzie, Southampton (GB)

Correspondence Address: IBM Corp;IP Law Dept T81/503, 3039 Cornwallis Road, PO Box 12195, Research Triangle Park, NC, 27709-2195, US

(73) Assignee: INTERNATIONAL BUSINESS MACHINES CORPORATION, ARMONK, NY (US)

(21) Appl. No.: 11/099,310

(22) Filed: Apr. 5, 2005

(30) Foreign Application Priority Data
May 8, 2004 (GB) 0410283.6

(51) Int. Cl. G06F 17/00

(52) U.S. Cl. 707/102

(57) ABSTRACT

A method and system for distribution of information are provided in a publish and subscribe system in which a publisher application transmits a message (210, 310) to one or more subscribing applications (208, 308) via a messaging infrastructure. The method includes receiving (203, 303) a message at a subscribing system (202, 302) and generating an event by the subscribing system to allow access to the message (210, 310) by a subscribing application (208, 308) at a reveal time (211, 311). A counting means (205, 305) on the subscribing system determines when it is the reveal time (211, 311) and the event is triggered at the reveal time (211, 311). A message (210) has a reveal time (211, 311) common to the one or more subscribing applications (208, 308).

### FIELD OF THE INVENTION

This invention relates to the field of distribution of information to multiple parties. In particular, the invention relates to publishing information to multiple clients in which one client is not favoured over another client.

### BACKGROUND OF THE INVENTION

Distribution of information electronically has become widespread due to the speed, efficiency and ease with which data can be provided over communications networks. The term information is used broadly to encompass all types of data including, for example, documents, visual data such as still or moving images, audio data such as music or speech, software, etc.

One form of electronic distribution of information is provided by messaging middleware. Messaging middleware is software that allows two or more applications to communicate by sending and receiving messages. The applications may be supported by different operating systems residing on a wide variety of hardware devices distributed geographically remotely from one another.

Messaging implementations include two basic models, a point-to-point model and a publish/subscribe model. In point-to-point models information is sent from a single sending application to a single receiving application. In publish/subscribe models a single sending application, or publisher, sends a message to multiple receiving applications, or subscribers. Subscribers register an interest in receiving messages from one or more publishers. The publisher creates a message and publishes it to the messaging middleware which then delivers it to the subscribers.

The publish/subscribe arrangement is suitable in situations where a single message is required by and distributed to multiple client applications. The publication operation is kept separate from the subscriptions and the publisher does not need to know anything about the type or number of subscribers. Subscribers can subscribe or unsubscribe at any time.

The messaging middleware is the intermediary acting between the publishers and subscribers. The messaging middleware matches publications to subscribers and handles the delivery of the messages. Messaging middleware can use various architectures including, for example, a hub and spoke architecture or a bus architecture. Communication is via any form of communication media including wireless networks, the Internet, etc.

In hub and spoke messaging architectures, the client applications are connected to a message server or broker which handles the communication between the client applications. The message broker coordinates the distribution of messages. It provides the routing of the messages, is responsible for the delivery of messages, and the authentication and authorisation of users. This form of architecture allows a client application to send a message to multiple subscriber client applications while only requiring a connection to the message broker. Also, the client application requires minimal messaging software as most of the messaging processing is carried out on the messaging broker.

In bus architectures, each client application contains messaging software to process messages itself. There is no centralised messaging server or broker. All the client applications are connected by a message bus which routes messages to the other client applications. For example, the message bus is typically the network layer of the IP multicast protocol.

In publish/subscribe systems the quality of service is normally dictated by the speed of delivery, reliability of the delivery, cost of the delivery, etc. of a message. The fairness of uniform distribution to client applications is an important aspect in a number of situations; however, this feature of publish/subscribe services has not been previously addressed.

There are a number of situations in which fairness across subscriber client applications is an important quality. Such situations include auction services in which each client must have an equal opportunity to bid and the bid must have an equal chance of being received by the auction service. There must be a level playing field in order for the auction to be fair resulting in each client having an equal opportunity to submit the winning bid.

Another situation may be in systems in disparate areas of the world where many people are contending for things as a result of a data feed. For example, many people worldwide may wish to book tickets to a prestigious sporting fixture when they become available. When a data feed announcing the sale of the tickets is received, the geographically distributed people will contend for a limited number of tickets. The opportunity to get a ticket should be fair across the world, without any advantage obtainable by some people receiving the data feed before other people,

Another situation is electronic examinations in which no candidate must see the examination paper before a set time or before any other candidate. All candidates must have a publication containing the examination paper either delivered at the set time or delivered ahead of the set time but only available to read at the set time.

Systems which use multicast as a means to distribute publication messages are by nature mostly fair. Multicast transmits a message from a single sender to multiple recipients on a network. This approach requires all client applications to be connected at the same time. Those client applications with faster network speeds are often marginally favoured.

In connected or disconnected systems, such as those that use replication, or data synchronisation technology to convey data from servers to client applications, the client applications are often not always connected to the publish/subscribe system concurrently. Therefore, some other mechanism is needed to provide this fairness.

### DISCLOSURE OF THE INVENTION

According to a first aspect of the present invention there is provided a method for distribution of information in a publish and subscribe system in which a publisher application transmits a message to one or more subscribing applications via a messaging infrastructure, the method comprising the steps of: receiving a message at a subscribing system; generating an event by the subscribing system to allow access to the message by a subscribing application at a reveal time; determining at the subscribing system when it is the reveal time; and triggering the event at the reveal time; wherein a message has a reveal time common to the one or more subscribing applications.

The subscribing system may maintain a list of events with corresponding reveal times for multiple messages received at the subscribing system.

The method may include the subscribing system receiving notification of the predetermined reveal time with the message and determining the reveal time by use of a counting means being synchronised with other participating subscribing systems. Alternatively, the step of determining the reveal time may be by use of a counting means counting a time from the delivery of the message at a subscribing system until the reveal time. In this case, the time from delivery may be notified to the subscribing system once receipt of the message is confirmed.

The subscribing system preferably includes messaging middleware which may handle messages on behalf of a subscriber application. The subscribing application may be local to the subscribing system or remote from it. The messaging middleware may be in the form of a local messaging broker for the subscriber application. The step of triggering the event may allow access to the message over an application interface.

The reveal time may be provided by a messaging infrastructure to which a publisher application sends a message. In this way, the reveal time is coordinated by a messaging infrastructure and not by the publisher application.

According to a second aspect of the present invention there is provided a method for distribution of information in a publish and subscribe system in which a publisher application transmits a message to one or more subscribing applications via a messaging infrastructure, the method comprising the steps of: receiving a message at a subscribing system; noting the time of receipt of the message; and responding to the message, marking the response with the time delay between receipt and response.

A counting means on the subscribing system may determine the delay from receipt of a message to response. A messaging infrastructure may process the responses in ascending order of delay between receipt and response for each subscribing application.

According to a third aspect of the present invention there is provided a system for distribution of information in a publish and subscribe system, comprising: a publisher application which generates a message; one or more subscribing applications supported by subscribing systems; a messaging infrastructure for processing and delivering the message to the one or more subscribing applications; wherein each subscribing system comprises: a receiving means for receiving a message; means for generating an event by the subscribing system to allow access to the message by a subscribing application at a reveal time; a counting means on the subscribing system determining when it is the reveal time; and means for triggering the event at the reveal time; wherein a message has a reveal time common to the one or more subscribing applications.

A notification of the predetermined reveal time may be included with the message and the counting means may be a clock synchronised with other participating subscribing systems. Alternatively, the counting means may count a time from the delivery of the message at a subscribing system until the reveal time. In this alternative, the system may include means for notifying the time from delivery to the subscribing system once receipt of the message is confirmed.

The subscribing system may include messaging middleware. The means for triggering the event may allow access to the message over an application interface.

The reveal time may be provided by a messaging infrastructure to which a publisher application sends a message.

According to a fourth aspect of the present invention there is provided a system for distribution of information in a publish and subscribe system, comprising: a publisher application which generates a message; one or more subscribing applications supported by subscribing systems; a messaging infrastructure for processing and delivering the message to the one or more subscribing applications; wherein each subscribing system comprises: a receiving means for receiving a message; means for noting the time of receipt of the message; and means for responding to the message, marking the response with the time delay between receipt and response.

A counting means on the subscribing system may determine the delay from receipt of a message to response. The messaging infrastructure may include means for processing the responses in ascending order of delay between receipt and response for each subscribing application.

According to a fifth aspect of the present invention there is provided a computer program product stored on computer readable storage medium, comprising computer readable program code means for a publish and subscribe system in which a publisher application transmits a message to one or more subscribing applications via a messaging infrastructure, the code means performing the steps of: receiving a message at a subscribing system; generating an event by the subscribing system to allow access to the message by a subscribing application at a reveal time; determining when it is the reveal time; and triggering the event at the reveal time; wherein a message has a reveal time common to the one or more subscribing applications.

According to a sixth aspect of the present invention there is provided a computer program product stored on computer readable storage medium, comprising computer readable program code means for a publish and subscribe system in which a publisher application transmits a message to one or more subscribing applications via a messaging infrastructure, the code means performing the steps of: receiving a message at a subscribing system; noting the time of receipt of the message; and responding to the message, marking the response with the time delay between receipt and response.

In each of the aspects of the present invention, the messaging infrastructure may take one of various different forms. In one embodiment, the messaging infrastructure may comprise one or more message brokers. In an alternative embodiment, the messaging infrastructure may comprise a bus architecture.

### BRIEF DESCRIPTION OF THE DRAWINGS

Embodiments of the present invention will now be described, by way of examples only, with reference to the accompanying drawings in which:

FIG. 1 is a simplified block diagram of a publish/subscribe system as known in the prior art;

FIG. 2 is a block diagram of a first embodiment of a message distribution system in accordance with the present invention;

FIG. 3 is a block diagram of a second embodiment of a message distribution system in accordance with the present invention; and

FIG. 4 is a block diagram of a third embodiment of a messaging distribution system in accordance with the present invention; and

### DESCRIPTION OF THE PREFERRED EMBODIMENTS

The described method and system provide message delivery in a publish/subscribe system in which multiple subscriber client applications are handled fairly.

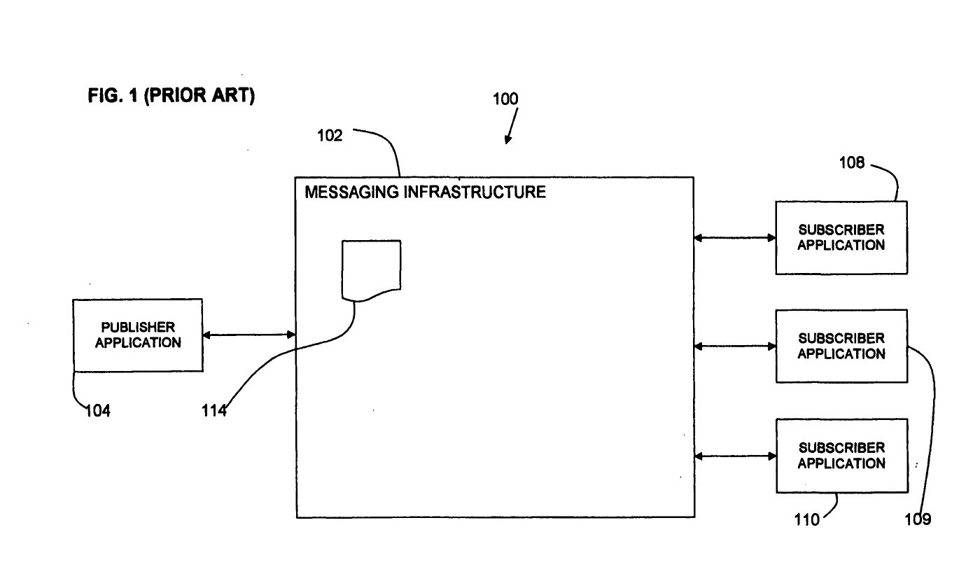

Referring to FIG. 1, a simplified arrangement of a known publish/subscribe system 100 is shown. A messaging infrastructure 102 is shown which processes the messages between a publisher client application 104 and subscriber client applications 108, 109, 110. The messaging infrastructure 102 in a publish/subscribe system 100 handles the processing, transformation and distribution of messages 114 passing between applications.

The messaging infrastructure 102 is shown generally and may be one or more messaging brokers connected via a network in the case of a hub and spoke architecture or a network layer with messaging functionality in the case of a bus architecture. Messaging middleware is provided on each of the client applications 104, 108, 109, 110 as well as in the messaging infrastructure 102 to provide the messaging logic.

In the case of the messaging infrastructure 102 being in the form of more than one message broker, the message brokers communicate with each other as a broker network in which publish/subscribe applications are interacting with any one of a number of connected brokers. Subscriptions and published messages are propagated through the broker network. Brokers can propagate subscription registrations through the network of connected brokers, and publications can be forwarded to all brokers that have matching subscriptions.

The client applications 104, 108, 109, 110 can be both publishers and subscribers. A publisher application 104 can publish a message 114 by sending it to or via the messaging infrastructure 102. Subscriber applications 108, 109, 110 also communicate with the messaging infrastructure 102 to subscribe to messages 114.

In the illustrated example, a publisher application 104 and three subscriber applications 108, 109, 110 are shown; however, it will be appreciated by a person skilled in the art that this is an example only and an infinite number of arrangements of applications is possible and only a very simple example is shown.

The publisher application 104 is not concerned with where the published messages are going, and the subscriber applications 108, 109, 110 need not be concerned where the messages they receive have come from. The messaging infrastructure 102 assures the validity of the message source, and manages the distribution of the messages according to the valid subscriptions registered in the messaging infrastructure 102.

An example of a messaging infrastructure for delivery of messages is WebSphere MQ Integrator provided by International Business Machines Corporation (WebSphere is a trade mark of International Business Machines Corporation).

Three embodiments of the present invention are described. In a first and second embodiment, the message is sent to subscribing client applications and is not available for the client applications to read until a predetermined reveal time. This ensures equity between the client applications as they can all access the message at the same time, whether or not they are connected at that time. In a first embodiment, a common time is established between all participating subscribing client applications and the client applications can only access the message at a predetermined reveal time. In a second embodiment a common time is not required, instead the reveal time is counted from the delivery of the message on each client application.

In a third embodiment, the message can be read by the subscribing client applications on receipt; however, a response is marked with the delay between receipt by the client application and the response being sent. This embodiment is useful in situations in which it does not matter if client applications read the message at different times but the response time is monitored and can be compared.

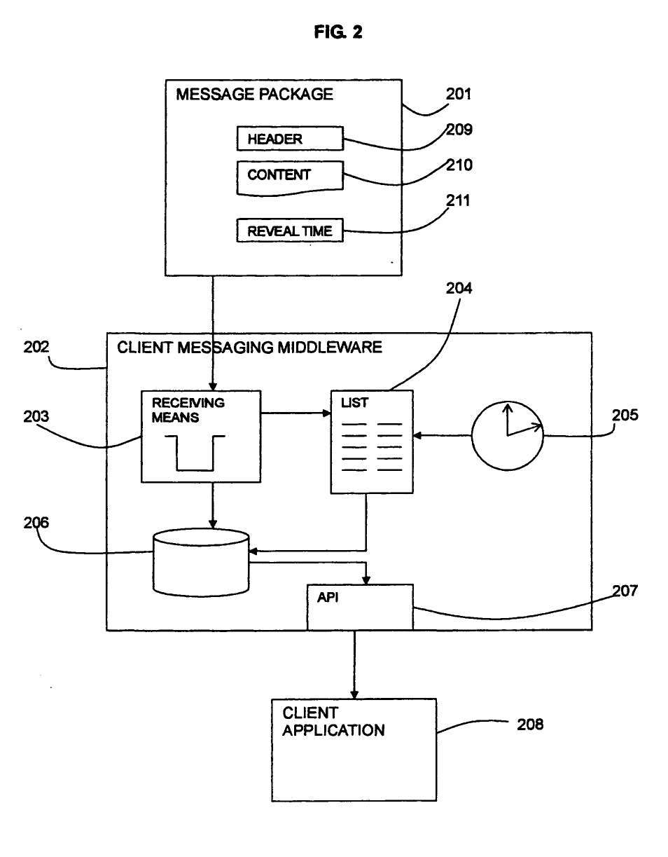

The three embodiments are now described in detail. Referring to FIG. 2, the first embodiment is described. A message package 201 is published via a messaging infrastructure and received by client messaging middleware 202 on a client system. The client messaging middleware 202 includes a receiving means 203, a list 204 of events and reveal times, a clock or counter means 205, storage means 206, for example, in the form of memory, disk storage or other virtual storage devices, which may be persistent or non-persistent, and an application interface 207 for communication with a client application 208.

The message package 201 includes a message header 209, a message content 210 and a reveal time 211. The message content 210 is not accessible in its received form. The message content 210 may be encrypted to prevent access to it before the reveal time. The reveal time 211 may be an exact time, a countdown of time, or a delta to some system generated time point, such as the arrival of the message at a server, or the time of posting of a publish message.

The client messaging middleware 202 handles the receipt of a message package 201. The message package 201 is received by the receiving means 203 and an event is set up in the list 204 referenced by the message header 209. The event is set up to fire on the reveal time 211. The message header 209 and the message content 210 are stored in the storage means 206, for example in the form of disk storage.

The client messaging middleware 202 has a clock or other form of counting means 205 which is synchronised to a common time or count between all participating subscribing client messaging middleware systems. When a reveal time of an event in the list 204 is reached by the clock or counter means 205, the event fires and the message content 210 is made available to the client application 208. The message content 210 is revealed to the client application 208 over the application interface 207.

In practice, the method of the first embodiment is as follows. Firstly, a common time is established between all the subscriber client systems. A publisher application publishes a message 201 via a messaging infrastructure. The messaging infrastructure is responsible for providing the reveal time for the message 201. The message flows from the messaging infrastructure to the subscriber client messaging middleware 202. The subscriber clients may receive the message 201 at different times but are unable to access the message content 210. The client messaging middleware 202 stores the message 201 persistently. All the clients wait until their system clocks reach a reveal time at which point the published message content 210 is passed to the client applications 208.

This method allows the clients to disconnect from the messaging infrastructure after the message package 201 has been received and before the reveal time.

Setting the reveal time is dependent on the expected time delays in getting all the required message packages to each subscriber client and is, therefore, topology and solution specific.

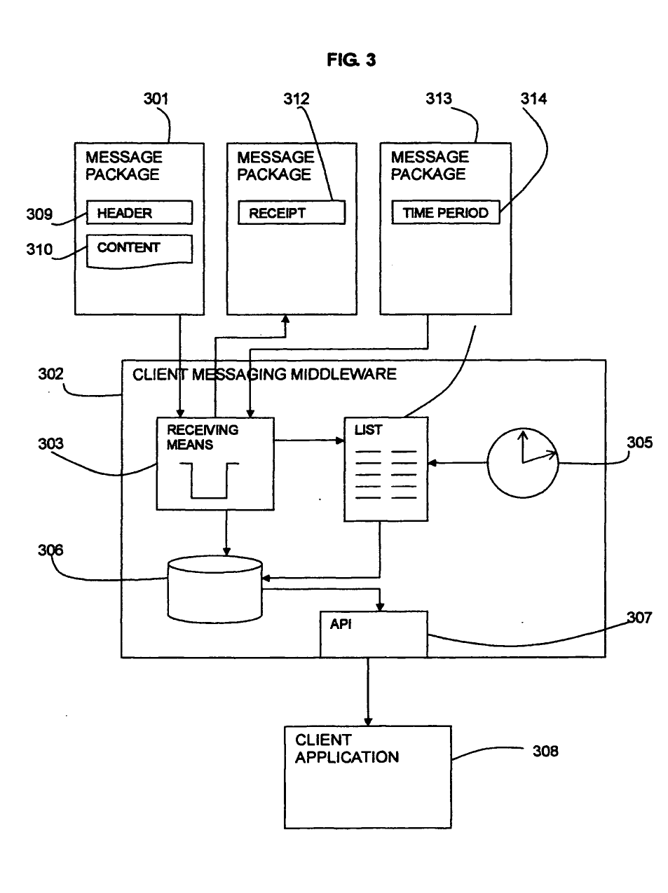

Referring to FIG. 3, the second embodiment is described with the corresponding reference numbers. A message package 301 is published via a messaging infrastructure and received by client messaging middleware 302. The client messaging middleware 302 includes a receiving means 303, a list 304 of events and time intervals, a timer or counter means 305, storage means 306 and an application interface 307 for communication with a client application 308.

The message package 301 includes a message header 309 and a message content 310. The message content 310 is not accessible in its received form. The message content 310 may be encrypted to prevent access to it before the reveal time.

The client messaging middleware 202 handles the receipt of a message package 301. The message package 301 is received by the receiving means 303 and an event is set up in the list 304 referenced by the message header 309. The event is set up to fire after a time period. The message header 309 and the message content 310 are stored in the storage means 306, for example in the form of disk storage.

In the case of the first embodiment, the clocks or counting means of all the participating client applications must be synchronised. In the second embodiment, the clocks or counting means are not synchronised. When a message package 301 arrives at the receiving means 303, the time or count until the reveal time is calculated for the receiving client. This time or count will depend on how long the message package took to be delivered to the particular receiving client.

The receiving means 303 sends a message of receipt 312 to the messaging infrastructure while still connected and a reply message 313 indicates the time period 314 until the message content 310 can be revealed. The messaging infrastructure calculates the time, for example in milliseconds, or a count from the time of sending its reply message until the reveal time. The time period is stored with the reference to the message in the list 304.

The timer or other form of counting means 305 in the client messaging middleware 302 provides the count and when a time period of an event in the list 304 has expired, the event fires and the message header 309 and message content 310 are made available to the client application 308. The message content 310 is revealed to the client application 308 over the application interface 307.

In practice, the method of the second embodiment is as follows. No common time is required to be established between client systems. Therefore, no communication is required to establish the common time. A publisher application publishes a message 301 via a messaging infrastructure. The message flows from the messaging infrastructure to the subscriber client messaging middleware 302. The subscriber clients may receive the message 301 at different times but are unable to access the message content 310. The client messaging middleware 302 stores the message 301 persistently. When the message 301 is received on each client system, the time period until that client can reveal the message content 310 is calculated while the client is still connected to the messaging infrastructure. All the clients wait until their designated time period has elapsed at which point the published message content 310 is passed to the client applications 308.

This embodiment has the advantage that the system clocks of each of the subscriber clients do not need to be synchronised. Each client system must have an accurate timer or counter for counting the time period.

This embodiment allows the clients to disconnect from the messaging infrastructure after the message package 201 has been received and after the time period has been set.

The reveal time from which the time period must be calculated must be chosen to allow for expected time delays in getting all the required message packages to each subscriber client and is, therefore, topology and solution specific.

The first and second embodiments are described in term of the client messaging middleware governing the access at the reveal time of the message content. As an alternative, a local broker could have the functionality to handle the access to the message content.

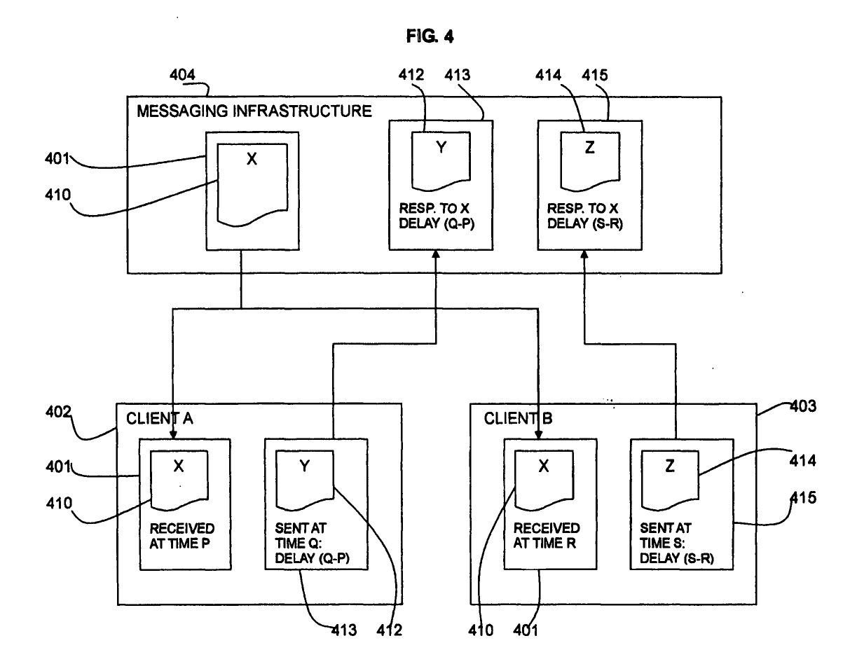

Referring to FIG. 4, the third embodiment is described. In this embodiment, as with the second embodiment, the subscriber client systems do not need to have synchronised system clocks with a common time. Subscriber client applications must not interact to exchange data unless it is through the messaging infrastructure publishing the message. This requirement must be enforced by the environment surrounding the activities of the client application or user of the system. For example, in the environment of a walk-in examination centre, the participants may be prevented from communicating, but can take several examination papers in the same time frame in any order. The examination centre must enforce the non-collaboration between users.

A message package 401 is published from a publisher application via a messaging infrastructure 404. Messaging middleware of subscriber client systems 402, 403 receive the message package 401. FIG. 4 shows a first client system A 402 and a second client system B 403. The messaging middleware of a client system has a clock or counting means and when it receives the message package 401, it marks the message package 401 with a time it was received. The client application can read the message content 410 in the message package 401 as soon as it is received by the client system 402, 403.

A response 412 to the message content 410 is created by a client application and the delay between the time of receiving the message at the client system and the time of sending the response is marked on the responding message package 413.

In the example shown in FIG. 4, the first client A 402 receives message X 401 at time P. Client A 402 sends a response Y 412 in a response message package 413. The response message package 413 is marked that it is in response to message X 401. The response message package 413 is sent from client A 402 at time Q with a time delay from time P to time Q marked in the response message package 413.

Similarly, the second client B 403 receives message X 401 at time R. Client B 403 sends a response z 414 in a response message package 415. The response message package 415 is marked that it is in response to message x 401. The response message package 415 is sent from client B 403 at time S with a time delay from time R to time S marked in the response message package 415.

The messaging infrastructure 404 waits for all responses within a reasonable time period. The messaging infrastructure 404 then processes the responses in ascending order of delay between receipt and response at each client.

In this embodiment, the client systems 402, 403 need only be connected to the messaging infrastructure 404 for receipt of the message package 401 and for sending the response packages 413, 415.

The third embodiment ensures that subscriber client applications are treated according to the time they took to respond to a message once it was received on their client system. This provides a fair and equal evaluation of the response times of each client to a message.

The described embodiments have the advantage that the reveal time is not governed by a publishing application. The messaging infrastructure controls the reveal times and, in the third embodiment, orders the responses according to the speed of response.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

1. A method for distribution of information in a publish and subscribe system in which a publisher application transmits a message to one or more subscribing applications via a messaging infrastructure, the method comprising the steps of:
receiving a message at a subscribing system;
generating an event by the subscribing system to allow access to the message by a subscribing application at a reveal time;
determining at the subscribing system when it is the reveal time; and
triggering the event at the reveal time;
wherein a message has a reveal time common to the one or more subscribing applications.

2. A method as claimed in claim 1, wherein the method includes the subscribing system receiving notification of the predetermined reveal time with the message and determining the reveal time by use of a counting means synchronised with other participating subscribing systems.

3. A method as claimed in claim 1, wherein the step of determining the reveal time is by use of a counting means counting a time from the delivery of the message at a subscribing system until the reveal time.

4. A method as claimed in claim 3, wherein the time from delivery is notified to the subscribing system once receipt of the message is confirmed.

5. A method as claimed in claim 1, wherein the subscribing system includes messaging middleware.

6. A method as claimed in claim 1, wherein triggering the event allows access to the message over an application interface.

7. A method as claimed in claim 1, wherein the reveal time is provided by a messaging infrastructure to which a publisher application sends a message.

8. A method as claimed in claim 1, wherein the messaging infrastructure comprises one or more message brokers.

9. A method as claimed in claim 1, wherein the messaging infrastructure comprises a bus architecture.

10. A method for distribution of information in a publish and subscribe system in which a publisher application transmits a message to one or more subscribing applications via a messaging infrastructure, the method comprising the steps of:
receiving a message at a subscribing system;
noting the time of receipt of the message; and
responding to the message, marking the response with the time delay between receipt and response.

11. A method as claimed in claim 10, wherein a counting means on the subscribing system determines the delay from receipt of a message to response.

12. A method as claimed in claim 10, wherein the messaging infrastructure processes the responses in ascending order of delay between receipt and response for each subscribing application.

13. A method as claimed in claim 10, wherein the messaging infrastructure comprises one or more message brokers.

14. A method as claimed in claim 10, wherein the messaging infrastructure comprises a bus architecture.

15. A system for distribution of information in a publish and subscribe system, comprising:
a publisher application which generates a message;
one or more subscribing applications supported by subscribing systems;
a messaging infrastructure for processing and delivering the message to the one or more subscribing applications;
wherein each subscribing system comprises:
a receiving means for receiving a message;
means for generating an event by the subscribing system to allow access to the message by a subscribing application at a reveal time;
a counting means on the subscribing system determining when it is the reveal time; and
means for triggering the event at the reveal time;
wherein a message has a reveal time common to the one or more subscribing applications.

16. A system as claimed in claim 15, wherein a notification of the predetermined reveal time is included with the message and the counting means is a clock synchronised with other participating subscribing systems.

17. A system as claimed in claim 15, wherein the counting means counts a time from the delivery of the message at a subscribing system until the reveal time.

18. A system as claimed in claim 17, wherein the system includes means for notifying the time from delivery to the subscribing system once receipt of the message is confirmed.

19. A system as claimed in claim 15, wherein the subscribing system includes messaging middleware.

20. A system as claimed in claim 15, wherein the means for triggering the event allows access to the message over an application interface.

21. A system as claimed in claim 15, wherein the reveal time is provided by a messaging infrastructure to which a publisher application sends a message.

22. A system as claimed in claim 15, wherein the messaging infrastructure comprises one or more message brokers.

23. A system as claimed in claim 15, wherein the messaging infrastructure comprises a bus architecture.

24. A system for distribution of information in a publish and subscribe system, comprising:
a publisher application which generates a message;
one or more subscribing applications supported by subscribing systems;
a messaging infrastructure for processing and delivering the message to the one or more subscribing applications;
wherein each subscribing system comprises:
a receiving means for receiving a message;
means for noting the time of receipt of the message; and
means for responding to the message, marking the response with the time delay between receipt and response.

25. A system as claimed in claim 24, wherein a counting means on the subscribing system determines the delay from receipt of a message to response.

26. A system as claimed in claim 24, wherein the messaging infrastructure includes means for processing the responses in ascending order of delay between receipt and response for each subscribing application.

27. A system as claimed in claim 24, wherein the messaging infrastructure comprises one or more message brokers.

28. A system as claimed in claim 24, wherein the messaging infrastructure comprises a bus architecture.

29. A computer program product stored on computer readable storage medium, comprising computer readable program code means for a publish and subscribe system in which a publisher application transmits a message to one or more subscribing applications via a messaging infrastructure, the code means performing the steps of:
receiving a message at a subscribing system;
generating an event by the subscribing system to allow access to the message by a subscribing application at a reveal time;
determining when it is the reveal time; and
triggering the event at the reveal time; wherein a message has a reveal time common to the one or more subscribing applications.

30. A computer program product stored on computer readable storage medium, comprising computer readable program code means for a publish and subscribe system in which a publisher application transmits a message to one or more subscribing applications via a messaging infrastructure, the code means performing the steps of:
receiving a message at a subscribing system;
noting the time of receipt of the message; and
responding to the message, marking the response with the time delay between receipt and response.
